(19) United States
(12) Patent Application Publication
(10) Pub. No.: US 2003/0107669 A1
(43) Pub. Date: Jun. 12, 2003

(54) Image pick-up device and portable electronic device having the same

(76) Inventors: Akira Ito, Narashino-shi (JP); Yoichi Seki, Narashino-shi (JP); Yoichi Nakano, Narashino-shi (JP); Hirobumi Okuyama, Narashino-shi (JP)

Correspondence Address: ADAMS & WILKS, 31st Floor, 50 Broadway, New York, NY, 10004, US

(21) Appl. No.: 10/314,575

(22) Filed: Feb. 10, 2003

(30) Foreign Application Priority Data
Dec. 7, 2001 (JP) 2001-374025

(51) Int. Cl. H04N 5/225; H04N 5/232; H04N 5/222

(52) U.S. Cl. 348/370; 348/373; 348/348; 455/556

(57) ABSTRACT

To provide an image pick-up device in which a lens does not need to be driven when information corresponding to the distance to an object to be photographed is obtained by using image information output by an image pick-up part. When a control part determines that an image is darker than a prescribed value based on a luminance signal contained in image information output by an image pick-up part, the control part stores the luminance signal in the image information input from the image pick-up part while a light emitting part does not emit light and then controls the light emitting part to emit light with a prescribed quantity. The control part stores the luminance signal in the image information output by the image pick-up art to obtain the luminance difference between the two luminance signals. When the luminance difference is not larger than a prescribed value, the control part controls the light emitting part to emit light with a prescribed quantity of light. When the obtained luminance difference is larger than the prescribed value, but not larger than another prescribed value, the control part controls the light emitting part to emit light with a quantity of light smaller than prescribed quantity. When the obtained luminance difference is larger than the other prescribed value, the control part controls the light emitting part to emit light with another prescribed quantity to perform a still image photographing operation.

### FIELD OF THE INVENTION

The present invention relates to an image pick-up device and a portable electronic device such as a portable telephone having the image pick-up device and, more particularly, to an image pick-up device and a portable electronic device such as a portable telephone capable of illuminating an object to be photographed.

### DESCRIPTION OF RELATED ART

When information corresponding to a distance is obtained in a digital still camera, there is sometimes employed an automatic focusing system (also referred to as a “sharpness detecting system”) in which the contrast of an image is obtained from image information obtained by an image sensor for picking-up an image, such as a CCD, and a focus lens is driven to maximize the contrast and focus the object. In such case, since the information corresponding to the distance to an object to be photographed is obtained by using the image sensor, the device structure can be simplified.

A structure using a range finding sensor separately from the image sensor to obtain distance information is disclosed in, for instance, Japanese Patent Laid-Open No. 184381/2000 and Japanese Patent Laid-Open No. 275033/2001.

Further, the distance information is used not only for the automatic focusing, but also for adjusting the exposure length upon stroboscopic photographing. Briefly described, when the distance to an object to be photographed is large, the exposure length at the time of stroboscopic photographing is increased. When the distance to an object to be photographed is short, an exposure length at the time of stroboscopic photographing is decreased.

For instance, in a portable electronic device such as a portable telephone provided with an image pick-up device, the distance to an object to be photographed is not obtained, so that control of the exposure length of stroboscopic light upon emission of stroboscopic light has not been carried out.

However, in the case of the sharpness detecting system, the focus lens needs to be driven, so that detection accuracy is inconveniently deteriorated due to bad conditions of a driving system. Further, since the focus lens is driven, it takes a relatively large time to obtain the distance information.

Further, when the range finding sensor is used separately from the image sensor for picking-up an image, the structure is not simplified. Still further, a portable electronic device such as a portable telephone having an image pick-up device does not detect the information corresponding to the distance to an object to be photographed, so that it has been impossible to control the quantity of stroboscopic light. When the distance to an object to be photographed is short, the amount of exposure has been inconveniently excessively increased to have a whitish photograph (image).

### SUMMARY OF THE INVENTION

It is an object of the present invention to provide an image-pick up device in which a lens does not need to be driven when information corresponding to a distance to an image to be photographed is obtained by using image information output from an image pick-up part.

It is another object of the present invention to provide a portable electronic device having an image pick-up device capable of controlling the amount of exposure upon stroboscopic photographing.

In accordance with a first aspect of the invention, an image pick-up device comprises an image pick-up part for picking up the image of an object to be photographed and outputting corresponding image information, a light emitting part for illuminating the object to be photographed, a release switch for instructing the image pick-up part to photograph a still image, and a control part for controlling the quantity of light emitted by the light emitting part upon photographing the still image on the basis of the image information output by the image pick-up part when the light emitting part emits light and the image information output from the image pick-up part when the light emitting part does not emit light.

According to the foregoing construction, the quantity of light emitted by the light emitting part upon photographing the still image can be controlled in accordance with information corresponding to a distance to an object to be photographed obtained on the basis of the image information output by the image pick-up part when the light emitting part emits light and the image information output by the image pick-up part when the light emitting part does not emit light. Accordingly, there is no need for driving a lens to obtain information corresponding to the distance to an object to be photographed by using the image information output by the image pick-up part, so the amount of exposure upon photographing the still image can be controlled without requiring a distance measuring time by driving the lens and the deterioration of control on the amount of exposure upon photographing the still image due to the imperfect drive of the lens can be prevented.

In accordance with a second aspect of the present invention, the control part controls the quantity of light emitted by the light emitting part upon photographing the still image on the basis of the difference between luminance detected from the image information output by the image pick-up part when the light emitting part emits the light and luminance detected from the image information output by the image pick-up part when the light emitting part does not emit the light. Accordingly, the quantity of light emitted by the light emitting part upon photographing the still image can be controlled in accordance with information corresponding to a distance to an object to be photographed obtained on the basis of the difference between luminance detected from the image information output by the image pick-up part when the light emitting part emits light and luminance detected from the image information output by the image pick-up part when the light emitting part does not emit the light, in addition to the above-described effects. Consequently, there is no need for driving a lens to obtain information corresponding to the distance to an object to be photographed by using the image information output by the image pick-up part and the deterioration of control of an amount of exposure upon photographing the still image due to the imperfect drive of the lens can be prevented.

In accordance with a third aspect of the present invention, the control part reduces the quantity of light of the light emitting part upon photographing the still image as the difference in luminance increases. According to such construction, the quantity of light emitted by the light emitting part can be controlled on the basis of the distance to an object to be photographed or the reflection factor of the object to be photographed in accordance with a feature that as the distance to an object to be photographed becomes shorter and the reflection factor of the object to be photographed becomes higher, the luminance difference increases, in addition to the above-described effects.

In accordance with a fourth aspect of the present invention, an image pick-up device comprises an image pick-up part for picking up the image of an object to be photographed and outputting corresponding image information, a light emitting part for illuminating the object to be photographed, and a control part for generating an output corresponding to a distance to the object to be photographed on the basis of image information output by the image pick-up part when the light emitting part emits light and image information output by the image pick-up part when the light emitting part does not emit light.

According to such construction, since the output corresponding to the distance to the object to be photographed is generated on the basis of the image information output by the image pick-up part when the light emitting part emits light and the image information output by the image pick-up part when the light emitting part does not emit light, there is no need for driving a lens because information corresponding to the distance to the object to be photographed is obtained by using image information output by the image pick-up part.

In accordance with a fifth aspect of the present invention, the light emitting part is an LED. Accordingly, the size of the light emitting part can be reduced and noise can be decreased in addition to the above-described effects.

In accordance with a sixth aspect invention, a portable electronic device is equipped integrally with the image pick-up device. According to such a construction, there can be provided a portable electronic device having an image pick-up device in which a focusing operation may be unnecessary when the information corresponding to the distance to the object to be photographed is obtained by using the image information output by the image pick-up part so that the amount of exposure can be controlled upon stroboscopic photographing.

### BRIEF DESCRIPTION OF THE INVENTION

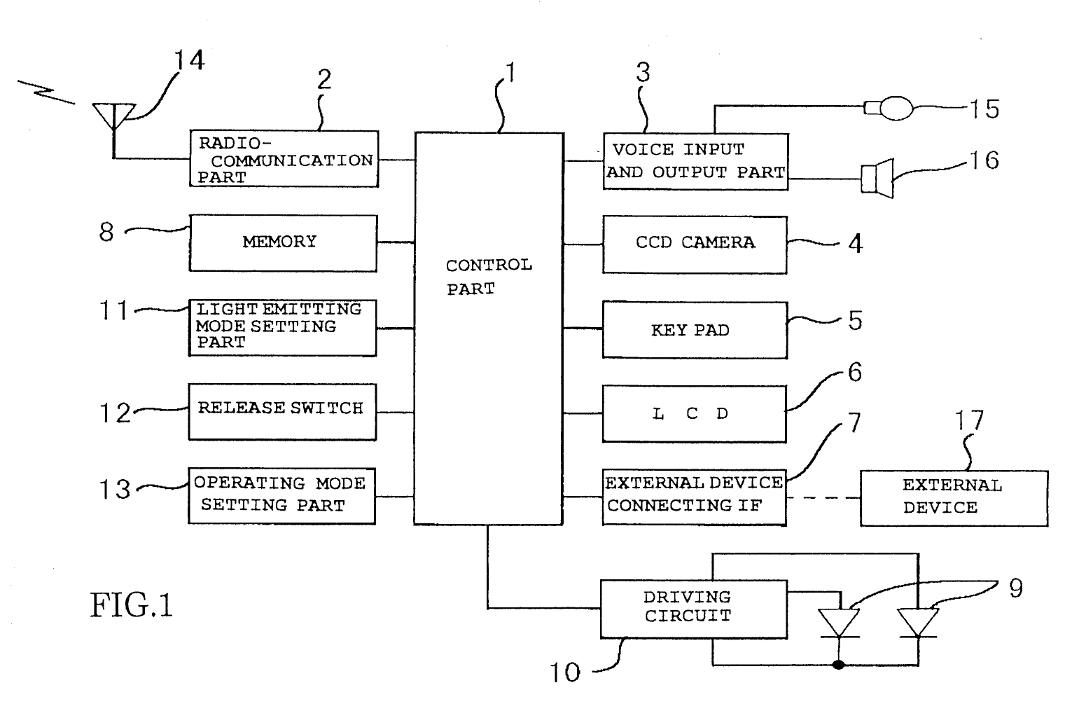

FIG. 1 is a functional block diagram showing one embodiment of the present invention;

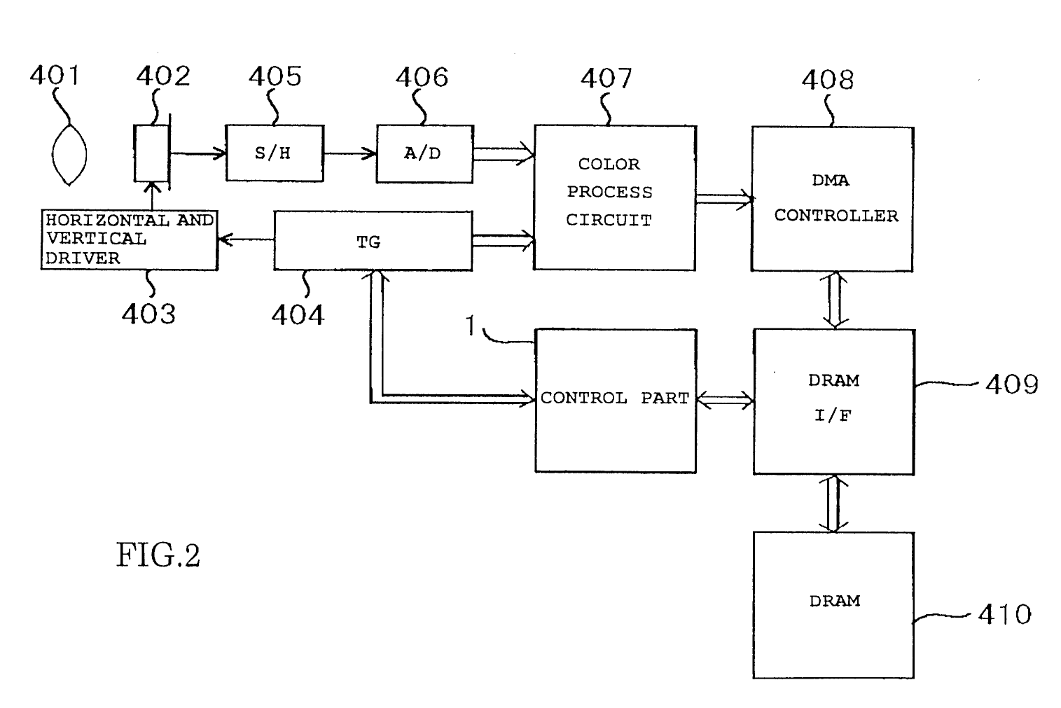

FIG. 2 is a block diagram showing a CCD camera in FIG. 1;

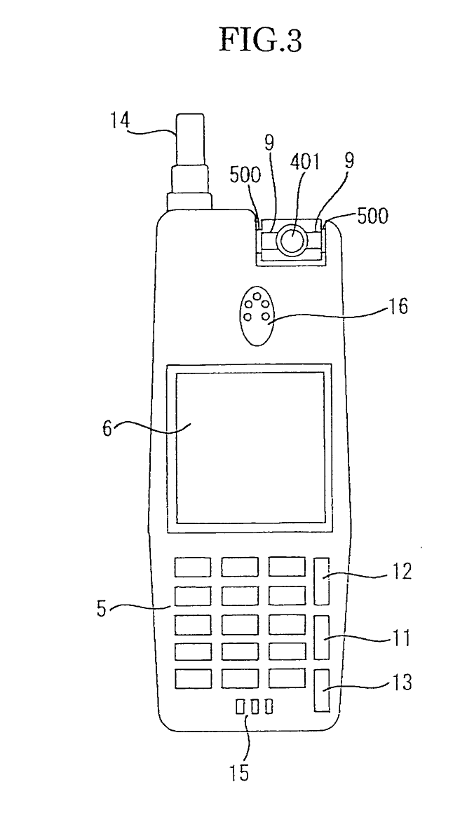

FIG. 3 is a front view showing an external appearance of the one embodiment of the present invention; and

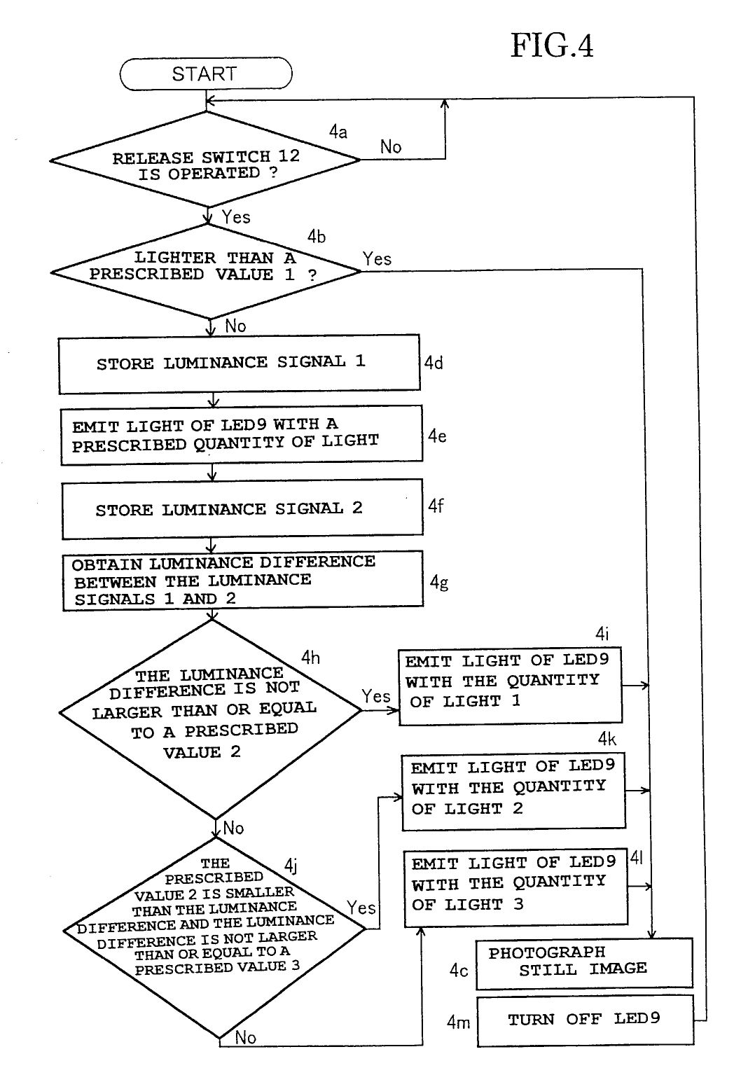

FIG. 4 is a flow chart for explaining an operation of FIG. 1.

### DETAILED DESCRIPTION OF THE PREFERRED EMBODIMENTS

Now, one mode for carrying out the present invention will be described with reference to embodiments shown in the drawings. In one embodiment, the invention will be described in the context of an image pick-up device incorporated in or provided with a portable electronic device comprising a portable telephone.

FIG. 1 is a functional block diagram showing the structure of the portable telephone. In the drawing, a control part 1 serves as a light quantity control part and comprises a microcomputer including a CPU, or the like, as a main component. A radio-communication part 2 is connected thereto, as is a voice input and output part 3, a CCD camera 4 serving as an image pick-up part, a keypad 5, a color LCD panel 6 serving as a display part, and an external device connecting interface (IF) 7, each of which is illustrated on the right-hand side of the control part 1 in FIG. 1.

Also connected to the control part 1 and shown below the control part in FIG. 1 is a driving circuit 10 for driving a white LED 9 serving as a light emitting part for generating light to illuminate an object to be photographed. As shown on the left-hand side of the control part 1 of FIG. 1, also connected to the control part 1 are a memory 8, a light emitting mode setting part 11 for setting the light emitting mode of the LED 9, a release switch 12 for outputting a release signal as an instruction to photograph an object, and an operating mode setting part 13 serving as a power switch.

An antenna 14 is connected to the radio-communication part 2. The voice input and output part 3 has a microphone 15 and a receiver 16 connected thereto.

When a transmitting voice is input, the microphone 15 converts it from an audio signal to an electrical signal, generates a voice transmitting signal, and outputs the voice transmitting signal to the voice input and output part 3. When the voice transmitting signal is supplied to the voice input and output part 3 from the microphone 15, the voice input and output part 3 amplifies and A/D converts the voice transmitting signal, and outputs the converted voice transmitting signal to the radio-communication part 2 through the control part 1. When the voice transmitting signal is supplied to the radio-communication part 2 from the voice input and output part 3 through the control part 1, the radio-communication part 2 performs known baseband and wireless communications processing on the voice transmitting signal and emits a broadband radio wave in a communication frequency band (for instance, a communication frequency band allocated to radio-communication using a code-division multi-origination connection (CDMA) system) or the like from the antenna 14.

When the antenna 14 receives a broadband radio wave in the designated communication frequency band, the radio communication part 2 performs radio and baseband processing on the received radio wave to generate a voice receiving signal, and outputs the voice receiving signal to the voice input and output part 3 through the control part 1. When the voice receiving signal is supplied to the voice input and output part 3 from the radio-communication part 2 through the control part 1, the voice input and output part 3 amplifies and D/A converts the voice receiving signal and outputs it to the receiver 16. The receiver 16 converts the voice receiving signal into an audio signal and outputs a corresponding receiving voice.

The CCD camera 4 picks-up the image of an object to be photographed and generates (by a process referred to as photoelectric transfer) image information corresponding to the photographed image. The image information is output to the control part 1.

The keypad 5 is comprised of various kinds of keys arranged in a desired manner, such as a “start” key, a redial key, an “end” key, numeric keys (including 0-9), an asterisk (*) key, a pound or sharp (#) key and function keys, etc. When one of the keys is pressed, a key operating signal corresponding to the pressed key is output to the control part 1. When the key operating signal is supplied to the control part 1 from the keypad 5, the control part 1 decodes the key operating signal to perform a process corresponding to the decoded result.

When a display signal is supplied to the LCD display panel 6 from the control part 1, the LCD panel 6 displays information corresponding to the supplied display signal.

In a preferred embodiment of the present invention, the external device 17 comprises a digital still camera, or the like, which photographs images similarly to the CCD camera 4. The external device connecting interface (IF) 7 receives the image information photographed by the external device 17 and outputs the received image information to the control part 1 when the portable telephone is connected to the external device 17. The display part is not limited to a color LCD panel and may be suitably changed to an organic EL display, etc.

The memory 8 forms part of the overall control means of the device in conjunction with the control part 1 and may comprise memory devices such as a flash memory, a ROM, a RAM, a VRAM (video RAM), and the like. The memory 8 stores executable programs in ROM. The control part 1 reads the executable programs and performs processes according to the various programs to execute the various operations described below. The flash memory in the memory 8 stores the image information input from the CCD camera 4 upon operation of the release switch 12 and the image information input from the external device connecting interface 7. The VRAM in the memory 8 stores the image information input from the CCD camera 4 and displayed on the LCD panel 6 or the image information input from the external device connecting interface 7. The RAM in the memory 8 is used for various kinds of processes.

The LED 9 serving as the light emitting part is an LED that is capable of illuminating an object to be photographed. In the presently described embodiment, a white LED for applying white light is employed. As the white LED, for instance, a high luminance white LED is used, such as model number: NSPW510BS produced by Nichia Kagaku Kogyo Co., Ltd., or the like. In FIG. 1, although two LEDs 9 are shown, the number of LEDs may be suitably changed. For example, since the quantity of light required for illuminating an object differs depending on the detection characteristics of a CCD (image sensor) used for the CCD camera 4, a change can be made in such a fashion that when a large quantity of light is necessary for lighting, the number of LEDs 9 is increased to increase the quantity of light, and when a large quantity of light for lighting is not necessary, a single LED is used.

In recent years, LEDs which emit light with high luminance under application of a driving voltage of about several tens of volts have been devised and put into practical use. For example, such LEDs have been used as light emitting devices in pen type lights or a lighting device attached to the head of a worker. In this connection, the light emitting part is not limited to a white LED and may be properly changed. For example, an LED which emits light of desired color, a light emitting part which emits the white light by combining red, green and blue LEDs together, or a lamp such as an electric bulb may be employed. When an LED is used, a compact form can be realized. Further, when a white LED is used as the light emitting part, the white light can be emitted by one LED, so that a more compact form can be obtained and the number of parts can be more reduced as compared to where red, green and blue LEDs are combined together to emit white light.

The driving circuit 10 drives the LED 9 on the basis of a light quantity control signal (output corresponding to a distance to an object to be photographed) by the control part 1 for controlling the quantity of light emitted by the LED 9. Since the light quantity control signal output by the control part 1 may comprise information for designating the quantity of light to be emitted by a white LED 9, consideration of white balance is not necessary as compared to the case where the quantity of light of the light emitting part for emitting white light is controlled by using a red LED, a green LED and a blue LED. Therefore, the light quantity control signal can be simplified.

The light emitting mode setting part 11 serves to set the light emitting mode of the LED 9. In the presently described embodiment, either an “automatic light emitting mode” in which light emission and quantity are automatically controlled depending on the luminance of an object to be photographed, or a “light emitting inhibit mode” in which light emission by the LED 9 is inhibited can be set. For instance, the modes are switched between the automatic light emitting mode and the light emitting inhibit mode each time the light emitting mode setting part 11 is operated. The control part 1 controls the light emission of the LED 9 in accordance with the mode set by the light emitting mode setting part 11 and displays the set mode on the LCD panel 6.

The operating mode setting part 13 can selectively set a state in which power is turned off (off mode), a state in which the transmitting and receiving operations of a telephone can be carried out (telephone mode), a state (view mode) in which image information stored in the memory 8 is displayed, a state in which a photographing operation by a camera can be carried out (photographing mode) and a state in which the light of the LED (light emitting part) 9 is continuously emitted with a prescribed quantity of light (luminance) (light mode). For instance, the operating modes are switched between the off mode, the telephone mode, the view mode, the photographing mode and the light mode each time the operating mode setting part 13 is operated. The control part 1 controls various operations depending upon the mode set by the operating mode setting part 13 and displays the set mode on the LCD panel 6. A telephone call can be received by the device in all of the aforementioned modes except for the off mode.

FIG. 2 is a block diagram showing portions of the CCD camera 4, the control part 1, and additional portions of the device. FIG. 2 shows a CCD 402 serving as an image pick-up element having a light receiving surface on which the optical image of an object to be photographed is formed by a photographing lens 401. The CCD 402 is a solidstate image pick-up element which performs a known photoelectric transfer operation for outputting an analog signal corresponding to the optical image and transfers an electric charge in the form of an array. The CCD 402 is a solidstate image sensor which converts two-dimensional optical information into a time-series electric signal (serial row).

The characteristics of the CCD 402 are described below. The CCD 402 includes a photoelectric transfer part in which many photoelectric transfer elements are arranged in the form of an array, a charge storage part for storing the output charges of the photoelectric transfer elements, and a charge reading part for reading the charge stored in the charge storage part in a prescribed system. Each of the photoelectric transfer elements forms a pixel. The CCD 402 in the present embodiment is a color CCD. Generally, since the pixel information itself of the CCD does not have color information, a color filter (a primary color filer using the three primary colors of light or a complementary color filter using the three primary colors) is mounted on the front surface of the color CCD.

A horizontal and vertical driver 403 and a timing generator (TG) 404 generate driving signals necessary for reading the CCD 402. Specifically, the horizontal and vertical driver and the timing generator 404 generate driving signals for transferring (reading) the information of the pixels for each row, while sequentially designating each column of the CCD 402, that is, they generate the horizontal and vertical driving signals respectively for serially reading out the pixel information.

A sample-and-hold (S/H) circuit 405 serves to sample the time-series signal (in this step, an analog signal) read out from the CCD 402 with a frequency adapted to the resolution of the CCD 402. After the sampling operation is performed, automatic gain control (AGC) may be carried out. An analog/digital converter 406 converts the sampled signal into a digital signal.

A color process circuit 407 generates a luminance/color difference multiplex signal (also referred to herein as a “YUV signal”) as the image information from the output of the analog/digital converter 406. A signal format of the YUV signal is composed of three blocks having a fixed length called “components” including respectively independently a luminance signal and two color difference signals and the ratio of length (bit number) of the respective components is called a component ratio.

A DMA controller 408 transfers data between the color process circuit 407 and a DRAM 410 (specifically, through a DRAM interface (I/F) 409) without interposing the control part 1, to thereby carry out memory transfer by a so-called direct memory transfer or direct memory access (DMA) operation. The DRAM interface 409 serves as a signal interface between the DRAM 410 and the DMA controller 408 and as a signal interface between the DRAM 410 and the control part 1.

FIG. 3 is a view showing the external appearance of the portable telephone according to the presently described embodiment. In FIG. 3, components which are the same or similar to those of FIGS. 1 and 2 are designated by the same reference numerals. The photographing lens 401, the CCD 402 and the LEDs 9 are integrally formed and capable of turning or rotating about an axis 500. Accordingly, a user can photograph himself or herself using the CCD camera 4. Since the image pick-up device using the LED as the light emitting part is equipped integrally with the portable telephone, noise can be further reduced, the form of the device can be made more compact, and the degree of freedom in design can be improved as compared to the related art using a xenon tube as a light emitting part. Further, since the white LED is used as the light emitting part, the structure can be simplified and the number of parts can be reduced as compared with a device using, for instance, a red LED, a green LED and a blue LED to generate light.

Now, operation of the preferred embodiment will be described.

When the telephone mode is set by the operating mode setting part 13, the control part 1 allows the functions of the portable telephone to be performed using the radio-communication part 2, the voice input and output part 3, the antenna 14, the microphone 15 and the receiver 16 so that the portable telephone can be used in the same manner as an ordinary portable telephone.

When the view mode is set by the operating mode setting part 13, the control part 1 supplies a display signal corresponding to the image information stored in the memory 8 (e.g., the VRAM) to the LCD 6 to display an image corresponding to the image information on the LCD panel 6.

When the light mode is set by the operating mode setting part 13, the control part 1 controls the LED 9 to emit a prescribed quantity of light (brightness). Accordingly, when the light mode is set, the portable telephone can be used as a lighting device. Further, as described below, since the LED (light emitting part) 9 used for photographing is also used for lighting, the structure can be simplified. Since the LED is used as the light emitting part, a more compact structure can be realized. In the light mode, the quantity of light of the LED 9 may be adjusted by operating the keypad 5.

When the photographing mode is set by the operating mode setting part, the control part 1 operates the CCD camera 4 to continuously fetch image information corresponding to the image of an object to be photographed. The image is obtained and output in real time by the CCD camera 4, which sends the image information to the LCD panel 6 through the VRAM, or the like, of the memory 8 and displays it on the LCD panel 6. The user determines a desired composition while viewing the LCD panel 6 in this state. At this time, the control part 1 recognizes the setting in the light emitting mode setting part 11.

When the automatic light emitting mode is set by the light emitting mode setting part 11, the operation thereof will be described with reference to FIG. 4.

In particular, when the release switch 12 is operated while the automatic light emitting mode is set (step 4a), if the control part 1 determines that an image displayed on the LCD panel 6 in accordance with a luminance signal included in image information input from the CCD camera 4 upon operation of the release switch 12 is lighter than a prescribed value 1 (in this case, it is assumed that the prescribed value 1 is stored in the memory 8) (step 4b), light is not emitted by the LED 9 to photograph a still image (step 4c). Specifically, immediately after the release switch 12 is operated, a YUV signal stored in the DRAM 410 is fixed and the fixed YUV signal is fetched through the DRAM interface 409 and the display of the LCD panel 6 is fixed to an image corresponding to the fixed YUV signal. The control part 1 applies, for instance, a JPEG encoding process to the fetched YUV signal and then stores the signal in the flash memory of the memory 8.

When the control part 1 determines that the image displayed on the LCD panel 6 in accordance with the luminance signal is darker than the prescribed value 1 (step 4b), the control part 1 determines that the periphery is dark and stroboscopic light is necessary, and stores the luminance signal, that is, a luminance signal (referred to hereinafter as “luminance signal 1”) included in image information input from the CCD camera 4 when the release switch 12 is operated while the LED (light emitting part) 9 does not emit light in the RAM of the memory 8 (step 4d) and controls the LED 9 to emit light with a prescribed quantity of light (step 4e).

The control part 1 stores a luminance signal (referred to hereinafter as “luminance signal 2”) included in image information corresponding to an image of an object to be photographed which is photographed by the CCD camera 4 when the LED 9 emits light with a prescribed quantity of light in the RAM of the memory 8 (step 4f).

When the storage of the luminance signal 2 is completed, the control part 1 obtains the luminance difference between the luminance signal 1 and the luminance signal 2 (step 4g).

The luminance difference obtained in the step 4g will now be described. A large luminance difference means that the quantity of light emitted by the LED 9, reflected by an object to be photographed and received by the CCD camera 4 is larger than the quantity of light received by the CCD camera 4 when the LED 9 does not emit light. A small luminance difference means that the difference between the quantity of light received by the CCD camera 4 when the LED 9 does not emit light and the quantity of light emitted by the LED 9, reflected by the object to be photographed and received by the CCD camera is small. As the distance to the object to be photographed becomes larger, the reflected light received by the CCD camera 4 is reduced. As the reflection factor of the object to be photographed becomes lower, the reflected light received by the CCD camera 4 is reduced.

Thus, a large or small luminance difference is equivalent to information corresponding the distance to the object to be photographed or the reflection factor of the object to be photographed. That is, the smaller the distance to the object to be photographed becomes, the larger the luminance difference becomes, and the higher the reflection factor of the object to be photographed becomes, the larger the luminance difference becomes.

When the obtained luminance difference is not larger than a prescribed value 2 (step 4h), the control part 1 determines that the amount of light from the LED 9 in the step 4e which is reflected by the object to be photographed is small and the reflection factor is low due to a remote object to be photographed and outputs to the driving circuit 10 a light quantity control signal for controlling the LED 9 to emit light with the quantity of light 1 (for example, a maximum quantity of light) from the LED 9 (step 4i). This light quantity control signal serves as an output corresponding to the distance to the object to be photographed and an output corresponding to the reflection factor of the object to be photographed.

When the obtained luminance difference is larger than the prescribed value 2 and not larger than a prescribed value 3 (however, in this case, the prescribed value 2<the prescribed value 3<the prescribed value 1, and these values are previously stored in the memory 8) (step 4j), the control part 1 determines that the distance to the object to be photographed is in a medium range and the reflection factor is about medium, and outputs to the driving circuit 10 a light quantity control signal for controlling the LED 9 to emit light with the quantity of light 2 (however, in this case, the quantity of light 1>the quantity of light 2) from the LED 9 (step 4k).

When the obtained luminance difference is larger than the prescribed value 3 (step 4j), the control part 1 determines that the distance to the object to be photographed is short and the reflection factor is high and outputs to the driving circuit 10 a light quantity control signal for controlling the LED 9 to emit light with the quantity of light 3 (however, in this case, the quantity of light 2>the quantity of light 3) from the LED 9 (step 41).

When the control part 1 performs the operations of steps 4i, 4k and 41, the control part 1 carries out the above-described still image photographing operation (step 4c). Specifically, after the light emission of the LED 9 is started, the YUV signal stored in the DRAM 410 is fixed, the fixed YUV signal is fetched through the DRAM interface 409 and the display of the LCD panel 6 is fixed to the image corresponding to the fixed YUV signal. The control part 1 applies, for instance, a JPEG encoding process to the fetched YUV signal, and then, stores the signal in the flash memory of the memory 8.

When the control part 1 completes the still image photographing operation, the control part 1 turns off the LED 9 (step 4m) and returns to step 4a.

As control systems for controlling the quantity of light, when a plurality of LEDs are provided, the number of LEDs 9 to be turned on may be changed or a driving current supplied to the same LED may be changed depending on the quantity of light. These systems may be combined together. In the case of a structure in which the quantity of light from the LED is controlled by changing the driving current supplied to the LED, the quantity of light can be controlled in the same LED. In the case of the structure in which the plural LEDs are provided and the quantity of light from the LEDs is controlled by changing the number of LEDs to be driven, the control of the quantity of light at least corresponding to the number of LEDs can be performed and the quantity of light can be increased more than that in the case of a single LED.

In the above description, although the quantity of light of the LED 9 is controlled in three steps, control is not limited to a step-wise method, nor is the number of steps limited to three steps and may be smaller or larger than the three steps depending upon the luminance difference.

As described above, the quantity of light emitted by the light emitting part upon photographing a still image can be controlled in accordance with information corresponding to the distance to an object to be photographed or the reflection factor of the object to be photographed obtained on the basis of image information output by the image pick-up part when the light emitting part emits light and image information output by the image pick-up part when the light emitting part does not emit light. Further, the quantity of light emitted by the light emitting part upon photographing a still image can be controlled in accordance with information corresponding to the luminance of the object to be photographed or the reflection factor of the object to be photographed obtained on the basis of the difference in luminance detected from the image information. Still further, as the distance to the object to be photographed becomes shorter, and the reflection factor of the object to be photographed becomes higher, the luminance difference becomes larger, and accordingly, if the quantity of light emitted by the light emitting part upon photographing a still image is controlled on the basis of the luminance difference, the quantity of light of the light emitting part can be controlled in accordance with the distance to the object to be photographed or the reflection factor of the object to be photographed. In addition, since an output corresponding to the distance to the object to be photographed is generated on the basis of image information output by the image pick-up part when the light emitting part emits light and the image information output by the image pick-up part when the light emitting part does not emit light, there is no need for driving a lens when information corresponding to the distance to the object to be photographed is obtained by using the image information output by the image pick-up part.

Further, since the image information used in order to decide whether or not a stroboscopic light is necessary upon photographing a still image is also used when information corresponding to the distance to the object to be photographed or the reflection factor of the object to be photographed is obtained, the image information detected once can be applied to a plurality of processes.

Further, since an LED is employed as the light emitting part for emitting light used for illuminating the object to be photographed, the light emitting part may be compact. Thus, the degree of freedom in design is improved. Still further, since the LED is easily controlled and may be turned on differently from a xenon tube, the LED may be used in various ways other than merely as a stroboscopic light upon photographing an image during low light conditions. For instance, the LED may be used to light the object to be photographed so that a user can obtain a composition when the periphery is dark. Hence, the maneuverability of the user is increased. Further, since a driving voltage of several hundred volts is not necessary it is for driving a xenon tube, noise resulting from the high voltage can be reduced and a limitation in design due to the noise can be further reduced.

Further, since the light emitting part serves as a light emitting part when object distance information or the reflection factor information of the object to be photographed is obtained as well as being used as a stroboscopic light upon photographing a still image when the release switch is operated, the structure is simplified.

When the photographing mode is set by the operating mode setting part, if the light emitting inhibit mode is set by the light emitting mode setting part 11, the control part 1 controls the LED 9 not to emit light and performs the still image photographing operation as in the above-described step 4c.

In the above description, although the structure using the CCD as the image pick-up part is employed, the present invention is not limited thereto, and any type of image sensor, such as a CMOS sensor, may be used.

In accordance with the above description, although an embodiment is described in which the image pick-up device is formed integrally with a portable electronic device comprising a portable telephone, the portable electronic device is not limited to the portable telephone. For instance, a different type of wireless communication device may be used, as may a notebook or hand-held personal computer or a portable information terminal.

When the image pick-up device of the present invention is equipped integrally with a portable electronic device for performing a wireless communications, such as a portable telephone, a lens does not need to be driven for performing a range finding operation, or an exclusive range finder may not be required.

In the above description, although the quantity of stroboscopic light is controlled in accordance with the luminance difference, since the luminance difference is information corresponding to the distance to an object to be photographed, for instance, driving means for driving the photographing lens 401 in the direction of an optical axis may be provided and this driving means may be driven in accordance with the luminance difference output by from the control part 1 so that the photographing lens 401 and the CCD 402 may be controlled to focus.

According to the present invention, the quantity of light emitted by the light emitting part upon photographing a still image can be controlled on the basis of the image information output by the image pick-up part when the light emitting part emits light and the image information output by the image pick-up part when the light emitting part does not emit light.

We claim:

1. An image pick-up device comprising:
an image pick-up part for picking up the image of an object to be photographed and outputting corresponding image information;
a light emitting part for illuminating the object to be photographed;
a release switch for outputting a photographing instruction for instructing the image pick-up part to obtain a still image; and
a control part for controlling the quantity of light emitted by the light emitting part when obtaining the still image according to a brightness determining process in which image information output by the image pick-up part when the light emitting part emits light is compared to image information output by the image pick-up part when the light emitting part does not emit light.

2. An image pick-up device according to claim 1; wherein the light emitting part is an LED.

3. A portable electronic device equipped with the image pick-up device according to claim 1.

4. An image pick-up device according to claim 1; wherein the control part controls the quantity of light emitted by the light emitting part when obtaining the still image on the basis of a difference between luminance detected from the image information output by the image pick-up part when the light emitting part emits the light and luminance detected from the image information output by the image pick-up part when the light emitting part does not emit the light.

5. An image pick-up device according to claim 4; wherein the light emitting part is an LED.

6. A portable electronic device equipped with the image pick-up device according to claim 4.

7. An image pick-up device according to claim 2; wherein the control part reduces the quantity of light emitted by the light emitting part when obtaining the still image as the difference in luminance increases.

8. An image pick-up device according to claim 1; further comprising a display part for displaying an image corresponding to the image information output by the image pick-up part.

9. An image pick-up device according to claim 1; further comprising a housing to which the image pick-up part, the light emitting part, and the release switch are mounted; a receiver contained in the housing for receiving a signal containing data; and a transmitter contained in the housing for transmitting a signal containing data.

10. An image pick-up device according to claim 9; further comprising a display provided on the housing and controlled by the control part for displaying an image contained in the image signal.

11. An image pick-up device according to claim 9; wherein the image pick-up part comprises a CCD camera.

12. An image pick-up device according to claim 9; wherein the image pick-up part is movably mounted to the housing.

13. An image pick-up device according to claim 9; wherein the image pick-up part is mounted to the housing such that a lens of the image pick-up part is pivotable about an axis.

14. An image pick-up device according to claim 9; wherein the control part controls the light emitting part to emit light during an image pick-up operation.

15. An image pick-up device comprising:
an image pick-up part for picking up the image of an object to be photographed and outputting corresponding image information;
a light emitting part for illuminating the object to be photographed; and
a control part for generating an output corresponding to a distance to the object to be photographed on the basis of a brightness determining process in which image information output by the image pick-up part when the light emitting part emits light is compared to image information output by the image pick-up part when the light emitting part does not emit light.

16. An image pick-up device according to claim 15; wherein the light emitting part is an LED.

17. A portable electronic device equipped with the image pick-up device according to claim 15.
